(19) United States
(12) Patent Application Publication
(10) Pub. No.: US 2026/0234373 A1
(43) Pub. Date: Aug. 13, 2026

(54) TRANSPARENT THERMOPLASTIC POLYURETHANE COMPOSITION, ARTICLE PRODUCED THEREFROM, AND USE THEREOF

(71) Applicant: BASF SE, Ludwigshafen am Rhein (DE)

(72) Inventors: Shi Yan FENG, Yokkaichi-shi, Mie (JP); Toru ORITA, Yokkaichi-shi, Mie (JP)

(73) Assignee: BASF SE, Ludwigshafen am Rhein (DE)

(21) Appl. No.: 19/154,057

(22) PCT Filed: Feb. 5, 2024
(86) PCT No.: PCT/EP2024/052734

§ 371 Date: Aug. 6, 2025

(30) Foreign Application Priority Data
Feb. 7, 2023 (EP) 23155298.5

(51) Int. Cl. C08K 9/06; C08J 3/12; C08K 3/36

(52) U.S. Cl. CPC C08K 9/06; C08J 3/12; C08K 3/36; C08J 2375/08; C08K 2201/006; C08K 2201/013

(57) ABSTRACT

Disclosed is a transparent thermoplastic polyurethane composition comprising, at least one pellets of a thermoplastic polyurethane; and an anti-blocking agent applied onto surfaces of the thermoplastic polyurethane pellets, wherein the anti-blocking agent comprises a hydrophobically surface-modified silica. An article produced from the transparent thermoplastic polyurethane composition and use thereof are also provided.

### TECHNICAL FIELD

The present disclosure relates to a transparent thermoplastic polyurethane, an article produced from the same, and use thereof.

### BACKGROUND

Thermoplastic polyurethane (TPU) is suitable for many applications, for example hoses, pipelines, windows, casings, sports items, and garments.

In most cases the articles are desired to possess a high transparency, which may be beneficial to optical devices or components.

Thermoplastic polyurethane is often shaped into pellets after manufacturing. During shipment and subsequent handling, the pellets need to remain free flowing and not stick together or agglomerate at the storage, shipping, and operating temperatures. To prevent blocking, the pellets can be treated with anti-blocking agent on their surface. However, anti-blocking agent as additive increases haze of TPU product made from the pellets.

EP1422259A1 disclosed thermoplastic polyurethanes with a low tendency towards surface tackiness of the granules. They are prepared by applying at least one wetting agent satisfying specified criteria and at least one solid powdering agent to the TPU before and/or after comminution of the TPU.

JP5479996B2 disclosed a particulate resin composition containing a thermoplastic resin and an anti-blocking agent. The anti-blocking agent is a polymer made from a monomer having one ethylenically unsaturated bond.

There is a need for thermoplastic polyurethane composition with high transparency and easy processibility.

### SUMMARY

An objective of the present disclosure is to overcome the problems of the prior art discussed above and to provide a transparent thermoplastic polyurethane. The thermoplastic polyurethane composition expresses a high optical transparency, low haze, and good processability.

Surprisingly, it has been found by the inventors that the above object can be achieved by a thermoplastic polyurethane composition comprising a plurality of thermoplastic polyurethane pellets and an anti-blocking agent applied onto surface of thermoplastic polyurethane pellets, wherein the anti-blocking agent comprises a hydrophobically surface-modified silica.

According to another aspect of the present disclosure, provided is an article produced from the transparent thermoplastic polyurethane composition.

In a further aspect, the present disclosure provides a use of the article.

It has been surprisingly found in this application that, by applying the anti-blocking agent comprising hydrophobically surface-modified silica onto the surface of the thermoplastic polyurethane pellets, the resulted thermoplastic polyurethane composition has good processability, high transparency, and low haze.

### DETAILED DESCRIPTION

Unless defined otherwise, all technical and scientific terms used herein have the meaning commonly understood by a person skilled in the art to which the present disclosure belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

Unless otherwise identified, all percentages (%) are “percent by weight”.

Unless otherwise identified, the temperature refers to room temperature and the pressure refers to ambient pressure.

Thermoplastic polyurethanes are segmented polymers having soft segments and hard segments. Soft segments are derived from isocyanate and the hydroxyl terminated polyol including polyether polyol, polyester polyol, or polycarbonate polyol. Hard segments are derived from isocyanate and chain extender. The chain extender is typically one or more small-molecular diols, such as 1,3-propane glycol or 1,4-butane glycol. The content of hard segments in a thermoplastic polyurethane can be calculated by dividing the sum of the weight of chain extender and the weight of isocyanate reacting with the chain extender by the total weight of the polyurethane.

The haze measurement of a transparent sample describes the proportion of light scattered when light passes through a transparent sample (scattering)>2.5°. The haze value therefore quantifies defects in the material which are present at the surface or within the structure and which impair transparency.

### Anti-Blocking Agent

To prevent pellets of thermoplastic polyurethane from sticking with each other, an anti-blocking agent is applied onto their surface. The anti-blocking agent may be applied through conventional ways, such as spray-coating, dry-blending, co-extrusion, extrusion with pellets, etc.

The anti-blocking agent according to the present disclosure comprises a hydrophobically surface-modified silica.

Preferably, the silica has an average specific surface area within a range of 30-200 m²/g, preferably 50-150 m²/g, more preferably 60-120 m²/g. It was surprisingly found that the hydrophobically surface-modified particulate silica with average specific surface area in such range can help reduce the haze caused by addition of anti-blocking agent.

The hydrophobically surface-modified silica preferably is a silica with silyl groups including without limitation to trimethylsilyl, triethylsilyl, tripropylsilyl, triisopropylsilyl, tributylsilyl, trihexylsilyl, tricyclohexylsilyl, triphenylsilyl, dimethylsilyl, diethylsilyl, dipropylsilyl, diisopropylsilyl, dibutylsilyl, dihexylsilyl, dicyclohexylsilyl, or diphenylsilyl groups on surface.

Preferably, the hydrophobically surface-modified silica is a silica with trimethylsilyl, triethylsilyl, tripropylsilyl, triisopropylsilyl, tributylsilyl, trihexylsilyl, tricyclohexylsilyl, or triphenylsilyl groups on surface and with a specific surface area within a range of 30-300 m²/g; or the hydrophobically surface-modified silica is a silica with dimethylsilyl, diethylsilyl, dipropylsilyl, diisopropylsilyl, dibutylsilyl, dihexylsilyl, dicyclohexylsilyl, or diphenylsilyl groups on surface and with a specific surface area within a range of 50-150 m²/g.

Preferably, the hydrophobically surface-modified silica is a silica with trimethylsilyl, triethylsilyl, tripropylsilyl, triisopropylsilyl, tributylsilyl, trihexylsilyl, tricyclohexylsilyl, or triphenylsilyl groups on surface and with a specific surface area within a range of 30-190 m²/g.

The hydrophobically surface-modified silica preferably is a fumed silica, a precipitated silica, or a combination thereof. Fumed silica often has a large specific surface area and is prone to surface modification.

Preferably, the surface modified silica has a content of from 100-1,500 ppm, preferably a content of from 200-1,000 ppm, based on a total weight of the transparent thermoplastic polyurethane composition.

Many hydrophobically surface-modified silicas are known and commercially available, e.g., from manufacturers such as Evonik Resource Efficiency GmbH, Tokuyama Corporation, etc. The hydrophobically surface-modified silica may also be prepared beforehand, by functionalizing the surface of silica with hydrophobic modifiers including without limitation to alkoxysilanes, halosilanes, aminosilanes, and organosilazanes. Exemplary alkoxysilanes, halosilanes, aminosilanes, and organosilazanes include without limitation to methoxytrimethylsilane, methoxytriethylsilane, ethoxytrimethylsilane, chlorotrimethylsilane, aminotrimethylsilane, hexamethyldisilazane, chlorotripropylsilane, chlorotriisopropylsilane, chlorotributylsilyl, chlorotrihexylsilane, chlorotricyclohexylsilane, chlorotriphenylsilane, etc. These compounds are known to be able to transfer silyl groups to silica surfaces and render the silica hydrophobic.

### Isocyanate

The thermoplastic polyurethane is based on an isocyanate. The isocyanate preferably is an organic isocyanate, more preferred is a diisocyanate. Further preferred the isocyanate is selected from the group consisting of aliphatic isocyanates, cycloaliphatic isocyanates, aromatic isocyanate, and a mixture thereof.

In some embodiments, the thermoplastic polyurethane is based on a diisocyanate selected from the group consisting of trimethylene diisocyanate, tetramethylene diisocyanate, pentamethylene diisocyanate (PDI), hexamethylene diisocyanate (HDI), heptamethylene diisocyanate, octamethylene diisocyanate, 2-methyl-pentamethylene 1,5-diisocyanate, 2-ethyl-butylene-1,4-diisocyanate, 1-isocyanato-3,3,5-trimethyl-5-isocyanatomethyl-cyclohexane (isophorone diisocyanate, IPDI), 1,4-bis(isocyanatomethyl)cyclohexane, 1,3-bis(isocyanatomethyl)cyclohexane (HXDI), 4,4′-dicyclohexylmethane diisocyanate, 2,4′-dicyclohexylmethane diisocyanate, 2,2′-dicyclohexylmethane diisocyanate (H12MDI), 1,4-cyclohexane diisocyanate, 1-methyl-2,4-cyclohexane diisocyanate, 1-methyl-2,6-cyclohexane diisocyanate, 2,2,4-trimethylhexamethylene diisocyanate, 2,4,4-trimethylhexamethylene diisocyanate (TMHDI), 2,4- or 2,6-toluene diisocyanate (TDI), 2,2′-, 2,4′-, or 4,4′-methylene diphenyl diisocyanate (MDI), and any mixture thereof.

Preferably, the thermoplastic polyurethane is based on an aliphatic or a cycloaliphatic diisocyanate.

More preferably, the thermoplastic polyurethane is based on 4,4′-dicyclohexylmethane diisocyanate, 2,4′-dicyclohexylmethane diisocyanate or 2,2′-dicyclohexylmethane diisocyanate (4,4′-, 2,4′-, or 2,2′-H12MDI), or any mixture thereof.

### Polyol

Polyol refers to a polyhydroxy compound. The polyol forming the thermoplastic polyurethane of the present disclosure comprises a polyester polyol, a polyether polyol, a polycarbonate polyol, or any combination thereof.

Preferably, the polyol forming the thermoplastic polyurethane having a functionality of 1.5 to 2.5, more preferably 1.8 to 2.3, and preferably a molecular weight of 500 g/mol to 5000 g/mol, more preferably a molecular weight of 500 g/mol to 3000 g/mol are examples of higher molecular weight compounds having at least two reactive hydrogen atoms.

Suitable polyester polyols include aliphatic polyester polyols and aromatic polyester polyols. Aliphatic polyester polyols include polymers and copolymers of one or more cyclic lactones (such as caprolactone); polymers and copolymers of hydroxyalkanoic acids such as lactic acid, 3-hydroxypropionic acid or glycolic acid (or cyclic dianhydride dimers thereof such as lactide or glycolide); and A-B type polyester polyols that correspond to the reaction product of one or more diols with one or more aliphatic dicarboxylic acids. Aromatic polyester polyols are generally A-B type polyester polyols that correspond to the reaction product of at least one diol with at least one aromatic carboxylic acid. The polyester polyol contains repeating units corresponding to the structure of each diol (after removal of each hydroxyl hydrogen) and repeating units corresponding to the structure of the dicarboxylic acid(s). As discussed below, various synthetic schemes can be used to make an A-B type polyester. By “diol”, it is meant a compound having exactly two hydroxyl groups/molecule and a molecular weight of up to 300, preferably up to 200 and more preferably up to 100. A-B type polyester polyols can be made with small amounts of branching agents (typically polyols having 3 or more hydroxyl groups per molecule), although such branching agents should be used in small proportions.

Examples of useful aliphatic A-B type polyester polyols include those corresponding to the reaction product of a diol such as 1,4-butanediol, hydroquinone bis(2-hydroxyethyl) ether, ethylene glycol, diethylene glycol, triethylene glycol, propylene glycol, dipropylene glycol, tripropylene glycol, 2-methyl-2-ethyl-1,3-propanediol, 2-ethyl-1,3-hexanediol, 1,5-pentanediol, thiodiglycol, 1,3-propanediol, 1,3-butanediol, 2,3-butanediol, neopentyl glycol, 1,2-dimethyl-1,2-cyclopentanediol, 1,6-hexanediol, 1,2-cyclohexanediol, 1,2-dimethyl-1,2-cyclohexanediol, and the like, with a dicarboxylic acid such as adipic acid, succinic acid, glutaric acid, azelaic acid, sebacic acid, malonic acid, maleic acid or fumaric acid.

Examples of useful aromatic A-B type polyester polyols include those corresponding to the reaction product of a diol such as 1,4-butanediol, hydroquinone bis(2-hydroxyethyl) ether, ethylene glycol, diethylene glycol, triethylene glycol, propylene glycol, dipropylene glycol, tripropylene glycol, 2-methyl-2-ethyl-1,3-propanediol, 2-ethyl-1,3-hexanediol, 1,5-pentanediol, thiodiglycol, 1,3-propanediol, 1,3-butanediol, 2,3-butanediol, neopentyl glycol, 1,2-dimethyl-1,2-cyclopentanediol, 1,6-hexanediol, 1,2-cyclohexanediol, 1,2-dimethyl-1,2-cyclohexanediol, and the like, with an aromatic dicarboxylic acid such as phthalic acid, isophthalic acid, terephthalic acid, tetrachlorophthalic acid and chlorendic acid.

Various reaction schemes can be used to form A-B type polyester polyols. One or more diacids as described above can be reacted directly with one or more diols as described above to make the polyester. Alternatively, anhydrides, dialkyl esters and acid halides of the dicarboxylic acids may be used as raw materials in the polymerization reaction, instead of or in addition to the dicarboxylic acid itself. It is also possible in some cases to form cyclic oligomers of the diol(s) and the dicarboxylic acid(s) (or corresponding dialkyl ester(s) or anhydride(s)) and to polymerize the cyclic oligomer to form the polyester. Cyclic oligomers can be prepared by forming a low molecular weight polymer from the polyol(s) and dicarboxylic acid(s) (or corresponding dialkyl ester(s) or anhydride(s)) and depolymerizing the low molecular weight polymer to form the cyclic oligomer(s). The cyclic oligomers may be a cyclic reaction product corresponding to that of one polyol molecule and one dicarboxylic acid molecule or may have a higher degree of polymerization.

Another category of polyester polyols is polylactone polyols, such as polycaprolactone, poly(lactic acid), or poly(glycolic acid), which are readily commercially available. These polylactone polyols are obtainable under the reaction between an initiator such as glycol, glycerol, or an amine; and a lactone such as polycaprolactone, lactide, or polyglycolide.

Various types of polyether polyols are suitable, including, for example, polymers of ethylene oxide, propylene oxide, 1,2-butylene oxide, 2,3-butylene oxide, tetramethylene oxide, and the like. Copolymers of two or more of these can be used. Preferred polyether diols include homopolymers of propylene oxide, random copolymers of propylene oxide and up to 20 weight percent ethylene oxide, propylene oxide-ethylene oxide random copolymers having terminal poly(ethylene oxide) endcaps, and poly(tetramethylene oxide).

Polyether diols and polyols having such low levels of unsaturation can be prepared using a variety of well-known double metal cyanide catalyst (DMC) complexes.

Hydroxyl group-containing polycarbonates include those of the known type such as those obtained by reaction of diols, e.g., 1,3-propanediol, 1,4-butanediol, and/or 1,6-hexanediol, 1,10-decanediol, neopentyl glycol, isosorbide, diethylene glycol, triethylene glycol or tetraethylene glycol and diaryl carbonates, e.g., diphenyl carbonate, or phosgene.

### Chain Extender

Further a chain extender is used as a building component in the synthesis of the thermoplastic polyurethane. The chain extender preferably is an aliphatic, araliphatic, aromatic and/or cycloaliphatic compound, preferably with a molecular weight of 50 g/mol to 500 g/mol, preferably with 2 groups reactive with isocyanate, which are also referred to as functional groups. The chain extender is either a single chain extender or a mixture of at least two chain extenders. The reaction of the isocyanate with the chain extender results in the formation of hard segments within polyurethane backbone whereas the polyol forms the soft segment. The content of hard segments in a thermoplastic polyurethane can be calculated by dividing the sum of the weight of chain extender and the weight of isocyanate reacting with the chain extender by the total weight of the polyurethane. Preferably, the thermoplastic polyurethane has a content of hard segments within a range of 20-60 wt. %, more preferably 30-45 wt. %, based on a total weight of the thermoplastic polyurethane.

The chain extender is preferably a difunctional compound, preferred examples being diamines or alkanediols having 2 to 10 carbon atoms in the alkylene radical, or a mixture thereof.

Preferably the chain extender is selected from 1,2-ethylendiol, 1,3-propanediol, 1,4-butanediol, 1,5-pentanediol, 1,6-hexanediol, 1,4-cyclohexanediol, isosorbide, and a mixture thereof.

### Catalyst

Catalyst which, in particular, accelerates the reaction between the NCO groups of the isocyanates and the hydroxyl groups of the polyol and the chain extender. Catalysts are optional in synthesis of thermoplastic polyurethanes.

### Other Additives

In preferred embodiments beside the anti-blocking agent, an additional auxiliary or additive is comprised in the composition. In a preferred embodiment the auxiliary or additive is selected from surfactants, nucleating agents, lubricants, demolding aids, dyes, pigments, antistatic agents, antioxidants, hydrolysis inhibitors, UV absorbers, light stabilizers, heat stabilizers, anti-discoloration agents, inorganic fillers, organic fillers, reinforcing agents, plasticizers, and any combination thereof.

### Production Process

Provided is a process of producing the transparent thermoplastic polyurethane composition according to the present disclosure. The process comprises:
1). Providing at least one pellets of a thermoplastic polyurethane and an anti-blocking agent; and
2). Applying the anti-blocking agent onto surface of the at least one pellets, Wherein the anti-blocking agent is a hydrophobically surface-modified silica.

The pellets of thermoplastic polyurethane may be prepared in-situ or ready-made. When the pellets are prepared in-situ, the pellets may be prepared from building components of thermoplastic polyurethane described above or prepolymer of thermoplastic polyurethane, or from shaping granulate, pellet, or powder form of commercial thermoplastic polyurethane. In the former case, a reaction extruder may be used to allow the building component to react and then shape the resultant thermoplastic polyurethane into pellets. In the latter case, the thermoplastic polyurethane may be processed by any known shaping machine and pelleted.

The process for preparing the thermoplastic polyurethane may be conducted discontinuously or continuously. A preferred process is the reaction extruder process, the belt line process, the “one shot” process, preferably the reaction extruder process or the “one-shot” process, most preferably the reaction extruder process.

The above-mentioned processes are used either by directly mixing the building components of isocyanate, polyol, chain extender, catalyst, optionally in the presence of additives or auxiliaries, or alternatively by applying the prepolymer process.

Polyisocyanate prepolymers are obtainable by reacting above-described isocyanate in excess, at temperatures of 30° C. to 100° C. with a polyol.

In the “one-shot” process, the building components isocyanate and polyol, and also the chain extender, are mixed with each other. This is done either in succession or simultaneously, in a preferred embodiment in the presence of the catalyst. In the extruder process, the building components diisocyanate, diol, the chain extender, and the catalyst are mixed. The mixing in the reaction extruding process is done preferably at temperatures between 100° C. and 280° C., preferably between 140° C. and 250° C.

The thermoplastic polyurethane may be shaped into pellets or powders after being cooled. In a preferred embodiment the shaping of the thermoplastic polyurethane is done in an extruder, more preferably a twin-screw extruder is used. The twin-screw extruder operates with positive conveying and thus allows a more precise setting of the temperature and output quantity on the extruder.

After the thermoplastic polyurethane is pelletized, the anti-blocking agent may be applied onto the surface of the pellets. The application may be achieved by ways known to skilled person, including but not limited to, blending, spraying, coating. For example, when preparing the pellets, the anti-blocking agent in its powdery form may be applied to the pelletizer and mixed with the pellets to coat their surface.

Auxiliaries and additives may be added during the synthesis of the thermoplastic polyurethane, or be added during compound process, or be added directly to the pellet of the thermoplastic polyurethane. The first two are preferred. This is especially the case, if the additive or auxiliary is not inert against the isocyanate, the chain extender, the compound reactive with isocyanate, or the catalyst.

### Applications

The transparent thermoplastic polyurethane composition according to the present disclosure may be processed to form an article. Preferably, the article is a cast article, an injection molded article, an extruded article, or a laminated article.

The article is used as a board, a plate, a film, a laminate, a tube, a hose, or a pipeline. They may find applications in transportation vehicles, constructions, sports items, medical devices, etc. High transparency and low haze level are advantageous for optical performance and visual appearance. For example, flexible displays, protection film, windshields of transportation vehicles, or windows of constructions are required to possess high light transmittance and low haze.

Preferably, the articles may be used in automobile windshields, aircraft windows, ballistic glazing, or construction windows.

The articles may be produced from the transparent thermoplastic polyurethane composition in various methods known to skilled person. The methods include without limitation to, injection molding, extrusion, calendaring, blow molding, laminating, rotational molding, etc.

### Examples

### Measuring and Test Methods

### (1) Measurement of Blocking Effect

The blocking effect of TPU pellets was measured as following with lower value indicating better anti-blocking performance:

15 g TPU pellets (2.8-3.3 mm for short axis and 3.7-4.2 mm for long axis diameter as near-elliptical pellet) were placed in a melt petri dish with diameter 7.5 cm and kept in 70° C. for 1 hour.

Then the petri dish was flipped, and the upside-down state was kept for 1 minute.

Finally, two kinds of pellets were weighted. The two kinds of pellets were:
Pellets a) the pellets sticking to the melt petri dish; and
Pellets b) the pellets dropping from the melt petri dish.

A blocking ratio was calculated as

$$B R = \frac{{w}_{a}}{{w}_{a} + {w}_{b}} \times 100 \%$$

BR denoted the blocking ratio, and wₐ and w_{b} denoted the weight of pellets a) and b), respectively.

### (2) Thickness Measurement of the TPU Plate or Film

The central part of the TPU plate or film was measured 10 times with a micrometer and the mean value was determined as the thickness of the TPU plate or film.

### (3) Measurement of Transmission Haze

Using a haze meter (HAZE METER NDH 5000, NIPPON DENSHOKU INDUSTRIAL Co., LTD., Japan), the transmission haze of the TPU plate or film was measured in accordance with JIS K7136 “Plastics-Determination of haze for transparent materials”.

### Materials

The materials used in the examples are as follows.

Dicyclohexylmethane 4,4′-diisocyanate (H12MDI), Cas No. 5124-30-1 from Wanhua Chemical Group Co., Ltd.

1,3-propanediol, CAS No. 504-63-2 from Okahata Co., Ltd.

1,4-butanediol, CAS No. 110-63-4, from BASF.

Poly(tetramethylene oxide) (PTHF) with Mn=1000 g/mol, CAS No. 25190-06-1, from BASF.

Silica 1, AEROSIL® NAX-50 from Evonik Resource Efficiency GmbH, hydrophobically modified fumed silica treated by hexamethyldisilazane, containing trimethylsilyl (TMS) groups, with specific surface area (SSA) of 30-50 m²/g.

Silica 2, AEROSIL® NX-130 from Evonik Resource Efficiency GmbH, hydrophobically modified fumed silica treated by hexamethyldisilazane, containing trimethylsilyl groups, with specific surface area of 80-120 m²/g.

Silica 3, Reolosil® HM-20L from Tokuyama Corporation, hydrophobically modified fumed silica treated by hexamethyldisilazane, containing trimethylsilyl groups, with specific surface area of 135-165 m²/g.

Silica 4, AEROSIL® R812 from Evonik Resource Efficiency GmbH, hydrophobically modified fumed silica treated by hexamethyldisilane, containing trimethylsilyl groups, with specific surface area of 230-290 m²/g.

Silica 5, AEROSIL® R972 from Evonik Resource Efficiency GmbH, hydrophobically modified fumed silica treated by dimethyldichlorosilane, containing dimethylsilyl (DMS) groups, with specific surface area of 90-130 m²/g.

Silica 6, AEROSIL® R976S from Evonik Resource Efficiency GmbH, hydrophobically modified fumed silica treated by dimethyldichlorosilane, containing dimethylsilyl groups, with specific surface area of 215-265 m²/g.

Silica 7, ADMAFINE® SO-C2 from Admatechs Co., Ltd., spherical silica, with specific surface area of 4-7 m²/g.

Silica 8, ADMAFINER SO-C1 from Admatechs Co., Ltd., spherical silica, with specific surface area: 10-20 m²/g.

Silica 9, AEROSIL® 50 from Evonik Resource Efficiency GmbH, hydrophilic fumed silica, with specific surface area: 35-65 m²/g.

Silica 10, AEROSIL® 130 from Evonik Resource Efficiency GmbH, hydrophilic fumed silica, with specific surface area: 105-155 m²/g.

Silica 11, AEROSIL® 300 from Evonik Resource Efficiency GmbH, hydrophilic fumed silica, with specific surface area: 270-330 m²/g.

### Preparation of TPU Plate

Thermoplastic polyurethanes used in examples 1 through 8 and comparative examples 1 through 6 were prepared from H12MDI and poly(tetramethylene oxide) with chain extender being a mixture of 1,4-butanediol (BDO) and 1,3-propanediol (PDO) in a weight ratio of 7:3. The content of hard segments in the thermoplastic polyurethanes was 35 wt. %. The thermoplastic polyurethanes were prepared by mixing and reacting the raw materials. The pellets were prepared by a pelletizer machine.

TPU pellets and the anti-blocking agent were dry blended to form TPU pellets with anti-blocking agent on the surface.

The thermoplastic polyurethane pellets with anti-blocking agent on their surface was processed by an injection molding machine (PLASTAR TM-130F2, Toyo Machinery & Metal Co., Ltd.) under 200° C. temperature to form a plate with a thickness of 2 mm.

Table 1 lists the haze values of different thermoplastic polyurethane compositions, in which information on the anti-blocking agents is also given. “TMS” refers to “trimethylsilyl” group and “DMS” refers to “dimethylsilyl”. Stoichiometry refers to the number of isocyanate groups divided by the total number of isocyanate-reactive groups (here hydroxyl groups in chain extenders and poly(tetramethylene oxide)).

TABLE 1
Properties of plates made from TPU pellets with anti-blocking agents

| | | | | Dosage | SSA | Haze | BR | |
|---|---|---|---|---|---|---|---|---|
| | Silica | Hydrophobic | Functionality | ppm | m²/g | value | % | Stoichiometry |
| Ex. 1 | 1 | Yes | TMS | 900 | 30-50 | 0.49 | <10 | 100% |
| Ex. 2 | 1 | Yes | TMS | 300 | 30-50 | 0.40 | <10 | 100% |
| Ex. 3 | 2 | Yes | TMS | 900 | 80-120 | 0.45 | <10 | 100% |
| Ex. 4 | 3 | Yes | TMS | 900 | 135-165 | 0.48 | <10 | 100% |
| Ex. 5 | 3 | Yes | TMS | 600 | 135-165 | 0.45 | <10 | 100% |
| Ex. 6 | 3 | Yes | TMS | 300 | 135-165 | 0.33 | <10 | 100% |
| Ex. 7 | 4 | Yes | TMS | 900 | 230-290 | 0.54 | <10 | 100% |
| Ex. 8 | 5 | Yes | DMS | 900 | 90-130 | 0.52 | <10 | 100% |
| C. Ex. 1 | 7 | No | — | 900 | 4-7 | 5.98 | <10 | 100% |
| C. Ex. 2 | 8 | No | — | 900 | 10-20 | 2.09 | <10 | 100% |
| C. Ex. 3 | 9 | No | — | 900 | 35-65 | 0.86 | <10 | 100% |
| C. Ex. 4 | 10 | No | — | 900 | 105-155 | 0.82 | <10 | 100% |
| C. Ex. 5 | 6 | Yes | DMS | 900 | 215-265 | 0.93 | <10 | 100% |
| C. Ex. 6 | 11 | No | — | 900 | 270-330 | 1.4 | <10 | 100% |

From Table 1, it can be observed that silica as anti-blocking agent is able to reduce the blocking ratio. Further, it is indicated that when using hydrophobically surface-modified silica as anti-blocking agent, the thermoplastic polyurethane composition can show a high transparency and low haze. More interestingly, thermoplastic polyurethane composition with hydrophobically surface-modified silica containing trimethylsilyl functionality, or some thermoplastic polyurethane composition with hydrophobically surface-modified silica containing dimethylsilyl functionality can express an even lower haze than surface-untreated silica, or part of that with hydrophobically surface-modified silica containing dimethylsilyl functionality. Among other factors, specific surface area of the anti-blocking agent also has impact on the haze performance of the resultant thermoplastic polyurethane composition. The hydrophobically surface-modified silica containing trimethylsilyl functionality and having a specific surface area of 30-300 m²/g is especially advantageous to achieve a low haze TPU composition. Similarly, the hydrophobically surface-modified silica containing dimethylsilyl functionality and having a specific surface area of 50-150 m²/g is especially advantageous. Compared with C.Ex. 5, Ex. 8 shows a much-lowered haze value.

1. A transparent thermoplastic polyurethane composition, comprising:
thermoplastic polyurethane pellets; and
an anti-blocking agent applied to at least one surface of the thermoplastic polyurethane pellets;
wherein:
the anti-blocking agent comprises a hydrophobically surface-modified silica; and
the hydrophobically surface-modified silica is:
a silica with trimethylsilyl, triethylsilyl, tripropylsilyl, triisopropylsilyl, tributylsilyl, trihexylsilyl, tricyclohexylsilyl, or triphenylsilyl groups on a surface, having a specific surface area of 30-300 m²/g; or
a silica with dimethylsilyl, diethylsilyl, dipropylsilyl, diisopropylsilyl, dibutylsilyl, dihexylsilyl, dicyclohexylsilyl, or diphenylsilyl groups on a surface, having a specific surface area of 50-150 m²/g.

2. The transparent thermoplastic polyurethane composition according to claim 1, wherein the hydrophobically surface-modified silica has a specific surface area within a range of 50-150 m²/g.

3. (canceled)

4. The transparent thermoplastic polyurethane composition according to claim 1, wherein:
the hydrophobically surface-modified silica is a silica with trimethylsilyl, triethylsilyl, tripropylsilyl, triisopropylsilyl, tributylsilyl, trihexylsilyl, tricyclohexylsilyl, or triphenylsilyl groups on a surface, having a specific surface area of 30-190 m²/g.

5. The transparent thermoplastic polyurethane composition according to claim 1, wherein the hydrophobically surface-modified silica is at least one selected from the group consisting of a fumed silica and a precipitated silica.

6. The transparent thermoplastic polyurethane composition according to claim 1, wherein the surface modified silica is present in an amount of 100-1,500 ppm, based on a total weight of the transparent thermoplastic polyurethane composition.

7. The transparent thermoplastic polyurethane composition according to claim 1, wherein the thermoplastic polyurethane is based on at least one chain extender selected from the group consisting of 1,2-ethanediol, 1,3-propanediol, 1,4-butanediol, 1,5-pentanediol, 1,6-hexanediol, 1,4-cyclohexanediol, and isosorbide.

8. The transparent thermoplastic polyurethane composition according to claim 1, wherein the thermoplastic polyurethane has a content of hard segments of 20-60 wt. %, based on a total weight of the thermoplastic polyurethane.

9. The transparent thermoplastic polyurethane composition according to claim 1, wherein the thermoplastic polyurethane is based on an aliphatic diisocyanate or a cycloaliphatic diisocyanate.

10. The transparent thermoplastic polyurethane composition according to claim 9, wherein the thermoplastic polyurethane is based on at least one selected from the group selected from 2,2′-dicyclohexylmethane diisocyanate, 2,4′-dicyclohexylmethane diisocyanate, and 4,4′-dicyclohexylmethane diisocyanate.

11. The transparent thermoplastic polyurethane composition according to claim 1, further comprising at least one additive selected from the group consisting of a surfactant, a nucleating agent, a lubricant, a demolding aid, a dye, a pigment, an antistatic agent, an antioxidant, a hydrolysis inhibitor, a UV absorber, a light stabilizer, a heat stabilizer, an anti-discoloration agent, an inorganic filler, an organic filler, a reinforcing agent, and a plasticizer.

12. An article produced from the transparent thermoplastic polyurethane composition according to claim 1.

13. The article according to claim 12, wherein the article is a cast article, an injection molded article, an extruded article, or a laminated article.

14. The article according to claim 12, where in the article is a form selected from the group consisting of a board, a plate, a film, a laminate, a tube, a hose, and a pipeline.

15. The article according to claim 12, wherein the article is provided in an automobile windshield, an aircraft window, a ballistic glazing, or a construction window.
